(19) United States
(12) Patent Application Publication
(10) Pub. No.: US 2005/0141376 A1
(43) Pub. Date: Jun. 30, 2005

(54) Control method of recording speed in optical disk drive

(75) Inventor: Yi-Chuan Pan, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/022,839

(22) Filed: Dec. 28, 2004

(30) Foreign Application Priority Data
Dec. 29, 2003 (TW) 92137349

(51) Int. Cl. G11B 5/09

(52) U.S. Cl. 369/47.38; 369/53.3

(57) ABSTRACT

The present invention discloses a control method of recording speed in an optical disk drive. Firstly an inserted disk is maintained at a predetermined rotation speed and then writing starts. If the presumed recording speed is higher than the data transfer rate (from the host to the buffer), the rotation speed is then lowered and the optical disk drive maintains the lowered rotation speed as the angular velocity and restarts writing with CAV mode.

This application claims the benefit of Taiwan application Serial No. 92137349, filed Dec. 29, 2003, the subject matter of which is incorporated herein by reference.

### BACKGROUND OF THE INVENTION

1. Field of the Invention

The invention relates in general to a control method of recording speed in optical disk drives, and more particularly to a method of speed control adopting constant angular velocity (CAV) recording mode.

2. Description of the Related Art

Generally speaking, a recordable optical drive can adopt one of the following optical disk (CD-R or CD-RW) recording modes:

(I) Constant Linear Velocity (CLV) Mode:

In a CLV mode, the track length passing through the optical pick-up head within a time unit is a constant. That is to say, when the optical pick-up head is accessing data from inner tracks of an optical disk, the disk rotation speed turns higher. To the contrary, when the optical pick-up head is accessing data from outer tracks of an optical disk, the disk rotation speed turns lower. Under CLV mode, the disk rotation speed is determined by the position of the optical pick-up head. That is, when the optical pick-up head moves from the inner tracks towards the outer tracks, the disk rotation speed slows down. Generally speaking, a 1× optical disk drive is defined as an optical disk drive whose relative speed between the optical pick-up head and the optical disk approximately ranges from 1.2 m/s to 1.4 m/s and whose data transfer rate equals 4.3218 MB/s. While in an n-× optical disk drive such as 2×, 4×, 8×, 16×, 20×, the relative speed and data transfer rate are n times of that in a 1× optical disk drive, wherein n is a positive integer.

(II) Constant Angular Velocity (CAV) Mode:

Under CAV mode, the optical disk rotation speed is a constant. That is to say, when the optical disk rotation speed is a constant, the recording speed in an inner track of an optical disk differs widely from that in an outer track. That is, when the optical pick-up head is recording data in inner tracks of an optical disk, the recording speed turns slower. To the contrary, when the optical pick-up head is recording data in outer tracks of an optical disk, the recording speed turns faster.

(III) Zoned Constant Linear Velocity (ZCLV) Mode:

In ZCLV mode, the tracks of an optical disk from inner tracks to outer tracks are divided into plural zones, and data are recorded onto every zone in a stable CLV control speed. As shown in FIG. 1, the recording speed in zone 1 is 16×, the recording speed in zone 2 is 20× (after time point T1), and the recording speed in zone 3 (after time point T2) is the maximum 24×. ZCLV mode uses super-link technology to connect T1 with T2, wherein the super-link technology is a technology capable of connecting recording interrupt points for successive recording such that the recording can be suspended and resumed. That is why links exist between zone 1 and zone 2 as well as between zone 2 and zone 3.

(IV) Partial Constant Angular Velocity (PCAV) Mode:

In the initial stage of PCAV mode, the inner tracks of an optical disk are recorded in a lower recording speed, so the recording speed turns higher when moving towards the outer tracks. When the recording speed is within the maximum recording speed of the optical disk or the maximum recording speed of the optical disk drive, the recording speed is maintained at this speed until the recording of data is finished. Referring to FIG. 2, a schematic diagram showing the relationship between the time position and the data transfer rate of an optical disk when recording data under PCAV mode is shown. Let time point T4 at an optical disk divides the optical disk into CAV zone and CLV zone. The spindle motor provides the optical disk a fixed rotation speed before time point T4, so the recording speed of the optical disk at the inner tracks starts with 4× at the beginning but reaches a recording speed of 10× at time point T4. After time point T4, data are recorded according to a constant linear velocity of 10×.

Refer to FIG. 3. Normally, when an optical disk drive is recording data, a host 1 sends to-be-recorded data to a buffer 3 of an optical disk drive (meanwhile, the data transmission speed is called the “data transfer rate”), a servo system 5 accesses data from the buffer 3 at a recording speed currently set in the optical disk drive, then the servo system 5 controls an optical pick-up head 7 to record the data.

When recording the data, the optical disk drive monitors the status of the buffer 3. If recording speed is higher than the data transfer rate, buffer under-run, which leads to writing fail, is likely to occur. Once the buffer is detected under-run, the servo system would normally send a command to reduce the recording speed, so that the recording speed can be reduced and the likelihood of buffer under-run can be reduced.

Refer to FIG. 4. Take CAV mode for example. When an optical disk drive starts recording, the spindle motor will have the optical disk maintained at a constant rotation speed, so the recording speed from inner tracks to outer tracks is getting higher and higher. However, if buffer under-run occurs during recording because the data transfer rate is too low, the servo system reduces the multiple of × as shown in FIG. 4. Since the host cannot achieve a data transfer rate of 40×, the servo system sends a command to reduce the recording speed. The original recording speed of 40× is reduced to 32× to continue recording or even reduced to 24× if the data transfer rate is still too low and so forth. However, the algorithm of reducing the number of speed times severely affects the efficiency of data recording, and the multiple of × is immediately reduced once a possible buffer under-run is detected. Despite the above practice guarantees the quality of data recording, the recording speed of an optical disk drive is severely delayed because the host cannot reach the maximum data transfer rate. Besides, the process of reducing the recording speed from 40× to 32× then further down to 24× is like zone shifting in ZCLV mode, and the occurrence of links, which cause difficulty when an optical disk drive is accessing or recording data, also exists.

Moreover, the above problems would still exist if writing fail occurs due to a poor-quality disk or other factors.

Therefore, a method which can effectively control the recording speed and maintain original quality method of recording.

### SUMMARY OF THE INVENTION

It is therefore an object of the invention to provide a control method of recording speed in an optical disk drive, whereby the inefficiency problem when recording an optical disk due to the switching algorithm of recording speed is resolved.

The invention achieves the above-identified object by providing a control method of recording speed in optical disk drive. First of all, the optical disk is maintained at a predetermined rotation speed for recording. If the presumed recording speed of writing a disk is higher than the data transfer rate from the host to the buffer, the rotation speed of the optical disk is reduced, the optical disk is maintained at the reduced rotation speed and is recorded under CAV mode.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram showing the relationship between the time and the data transfer rate of an optical disk when data are recording according to ZCLV mode;

FIG. 2 is a schematic diagram showing the relationship between the time and the data transfer rate of an optical disk when recording data according to PCAV mode;

FIG. 3 is a schematic diagram showing the flow of data when an optical disk drive is recording data according to prior art;

FIG. 4 is a diagram showing the relationship between the time and the recording speed of an optical disk according to prior art when the recording speed is reduced;

FIG. 5 is a process control chart of switching recording speed according to the invention; and

FIG. 6 is a diagram showing the relationship between the time and the recording speed of an optical disk according to the invention when recording data.

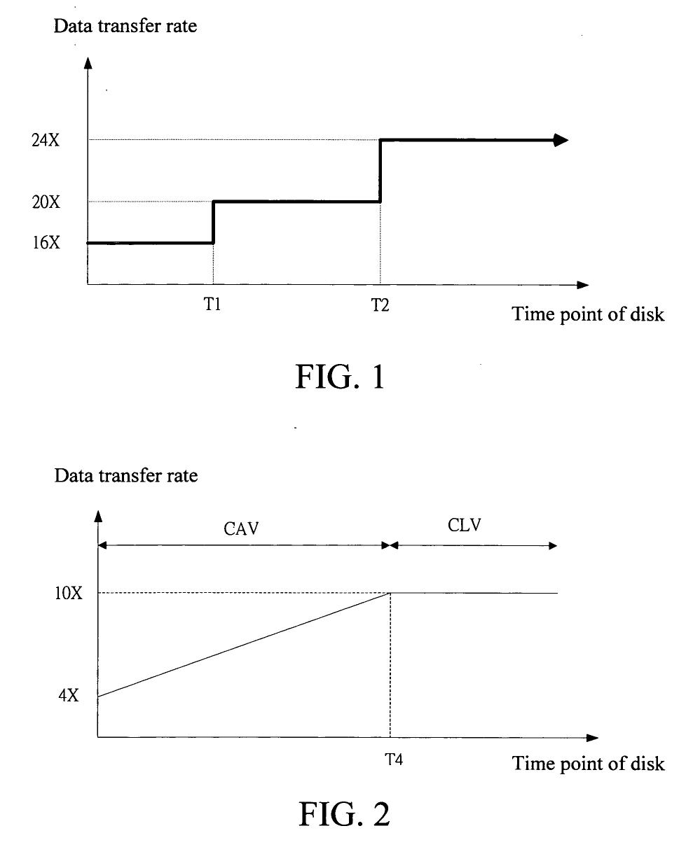

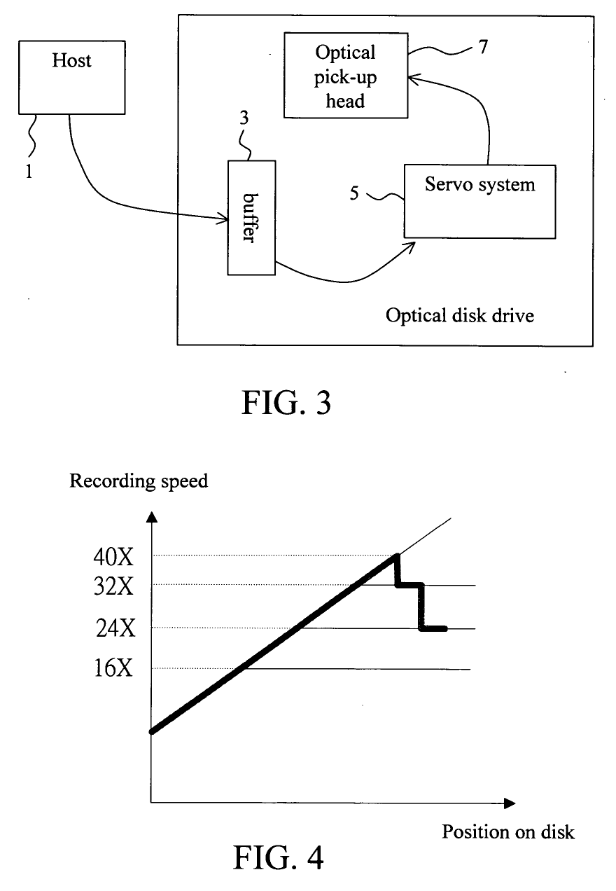

### DETAILED DESCRIPTION OF THE INVENTION

The invention overcomes the above-identified inefficiency problem when recording an optical disk due to the switching algorithm of recording speed by controlling the recording speed according to the data transfer rate of the host.

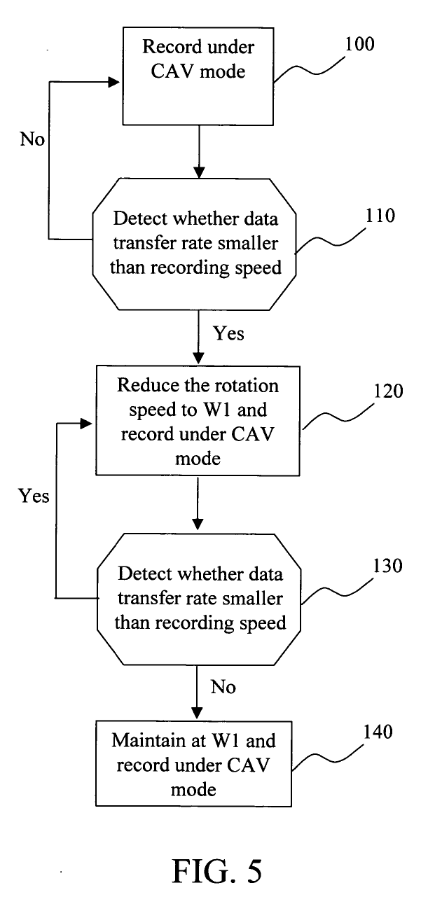

Referring to FIG. 5, a flow chart of a control method recording speed according to an embodiment of the invention is shown.

Step 100: recording data according to a predetermined CAV mode of an optical disk drive. That is, a spindle motor has an optical disk maintained at a constant rotation speedwhen data are recorded into the optical disk from inner tracks to outer tracks.

Step 110: determining if the data transfer rate is lower than the recording speed. If so, proceed to step 120; otherwise, return to step 100. When the data transfer rate is too low causing buffer under-run to occur, the recording speed is changed to prevent the occurrence of the above problems (that is, proceed to step 120).

Step 120: reducing the optical disk rotation speed to W1 and continuing to record under CAV mode. When the rotation speed is reduced, the recording speed of an optical disk is reduced accordingly. Since the reduction in rotation speed is insignificant, the recording speed does not have significant change. Furthermore, after the rotation speed is reduced, the optical disk drive continues to adopt CAV mode, so the recording speed variates according to the recorded position of the optical disk.

Step 130: determining if the data transfer rate is lower than the recording speed. If so, proceed to step 120; otherwise, proceed to step 140. When reducing the rotation speed and recording under CAV mode, the detection of the occurrence of buffer under-run still continues. If the buffer under-run occurs, the optical disk rotation speed is further reduced (that is, return to step 120).

Step 140: maintaining W1 and continuing to record under CAV mode.

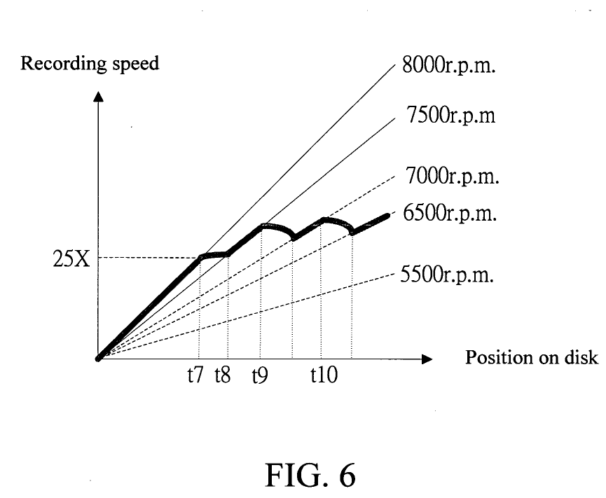

FIG. 6 is a diagram of the recording speed versus the position of the optical disk according to the preferred embodiment of the invention. Initially, the optical disk rotation speed is set to be 8000 rpm, CAV mode is adopted for recording, and the status of the buffer is monitored. Since CAV mode is adopted, the recording speed becomes higher and higher. While the data transfer rate from the host to the buffer detected at time point t7 is lower than the predetermined recording rate of 25× and is likely to cause buffer under-run. Meanwhile, the optical disk rotation speed is reduced to 7500 rpm, and the recording speed of optical disk is maintained at CAV mode with 7500 rpm. That is to say, the optical disk drive switches the slope of recording speed under CAV mode. Since CAV mode is adopted for recording after the switching of rotation speed, the recording speed becomes higher according to disk position after time point t8.

The data transfer rate is once again detected to be too slow at time point t9, meanwhile, the optical disk rotation speed is reduced to prevent the occurrence of buffer under-run, and the recording of data continues under CAV mode. Similarly, when recording an optical disk, the data transfer rate at time point t10 is detected to be too slow again, and the optical disk rotation speed needs to be further reduced to prevent the occurrence of buffer under-run.

The above preferred embodiment uses data transfer rate to determine the timing of reducing the rotation speed, while another preferred embodiment can determine the timing of reducing the rotation speed according to the data volume of buffer, the servo signal (the thickness of tracking error signal or the quality of focusing error signal) or if the ATIP error rate is higher than a thershold value.

Therefore, the invention has the advantage of flexibly adjusting the recording speed so as to switch the slope of CAV mode as required. The recording speed is determined according to the data transfer rate of the host so that the average recording speed can be improved effectively.

The invention has another advantage of being free of the occurrence of links. The rotation speed is not switched significantly, so the recording speed will not have significant change and links will not occur. When accessing an optical disk recorded according to the above-disclosed method, the optical disk drive will not suffer from data discontinuity.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A control method of recording speed in an optical disk drive when recording an optical disk under CAV mode, the method comprising:
maintaining the optical disk at a predetermined rotation speed when recording;
if a predetermined recording speed of the optical disk is higher than a data transfer rate from the host to the buffer, reducing the rotation speed of the optical disk to a first rotation speed; and
maintaining the optical disk at the first rotation speed and continuing recording under CAV mode.

2. A control method of recording speed in an optical disk drive comprising:
determining if a predetermined recording speed of an optical disk drive is higher than a data transfer rate from host to buffer when recording; and
if so, reducing the rotation speed of the optical disk and continuing recording under to CAV mode.

3. A control method of recording speed in an optical disk drive when recording an optical disk under CAV mode, comprising:
maintaining the optical disk at a predetermined rotation speed when recording:
if the ATIP error rate is higher than a predetermined value, reducing the rotation speed of the optical disk to the first rotation speed; and
maintaining the optical disk at the first rotation speed and continuing recording under CAV mode.

4. A control method of recording speed in an optical disk drive when recording an optical disk under CAV mode, comprising:
maintaining the optical disk at a predetermined rotation speed when recording;
if the data volume of a buffer is less than a predetermined volume, reducing the rotation speed of the optical disk to the first rotation speed; and
maintaining the optical disk at the first rotation speed and continuing recording under CAV mode.

5. A control method of recording speed in an optical disk drive, recording an optical disk under CAV mode and comprising the steps of:
maintaining the optical disk at a predetermined rotation speed when recording;
if a servo signal is inferior to a predetermined tolerance range, reducing the rotation speed of the optical disk to the first rotation speed; and
maintaining the optical disk at the first rotation speed and continuing recording under CAV mode.
